(19) United States
(12) Patent Application Publication
(10) Pub. No.: US 2023/0057255 A1
(43) Pub. Date: Feb. 23, 2023

(54) MULTIFUNCTIONAL GUITAR

(71) Applicant: Huizhou Enya Musical Instrument Co., Ltd., Huizhou (CN)

(72) Inventor: Haiming HU, Huizhou (CN)

(21) Appl. No.: 17/724,481

(22) Filed: Apr. 19, 2022

Related U.S. Application Data
(63) Continuation of application No. PCT/CN2021/138315, filed on Dec. 15, 2021.

(30) Foreign Application Priority Data
Aug. 18, 2021 (CN) 202110949109.X

(51) Int. Cl. G10D 1/08; G10D 3/00; G10H 3/18; H04R 1/02

(52) U.S. Cl. CPC G10D 1/085; G10D 3/00; G10H 3/186; H04R 1/026; G10H 2240/321; H04R 2420/07

(57) ABSTRACT

A multifunctional guitar includes a guitar body, a handle detachably connected to the guitar body, a Bluetooth speaker, and a shock absorbing mechanism that connects the Bluetooth speaker to the guitar body.

### CROSS REFERENCE TO RELATED APPLICATIONS

The present application is a continuation-application of International Application PCT/CN2021/138315, with an international filing date of Dec. 15, 2021, which claims foreign priority of Chinese Patent Application No. 202110949109.X, filed on Aug. 18, 2021 in the China National Intellectual Property Administration of China, the contents of all of which are hereby incorporated by reference.

### BACKGROUND

### 1. Technical Field

The present disclosure generally relates to guitars, and particularly to a multifunctional guitar.

### 2. Description of Related Art

Electric guitars are the product of modern science and technology, and differ from traditional guitars in appearance and sound. Typically, an electric guitar is equipped with devices such as volume, pitch adjuster and tremolo structure. With the use of effects units, electric guitars have strong expressive power and play an important role in modern music.

Typically, an electric guitar can be connected to an external speaker through a cable. The pickup on the electric guitar converts the vibration signal into an electrical signal, and the electrical signal is transmitted to the external speaker through the cable, and then the sound is amplified by the external speaker.

Some conventional electric guitars are typically made of a single piece of hardwood. On the one hand, such a traditional structural design makes the electric guitar bulky and inconvenient to carry. On the other hand, electric guitars made of a single piece of hardwood are not easy to hold due to the lack of a handle.

Therefore, there is a need to provide a multifunctional guitar to overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views. Obviously, the drawings in the following description are only some embodiments of the present disclosure. For those of ordinary skill in the art, other drawings can be obtained based on these drawings without creative labor.

FIG. 1 is a schematic isometric view of a multifunctional guitar according to one embodiment.

FIG. 2 is a partly exploded view of the multifunctional guitar.

FIG. 3 is an enlarged view of a portion A of FIG. 2.

FIG. 4 is another partly exploded view of the multifunctional guitar.

FIG. 5 is a planar view of the multifunctional guitar.

FIG. 6 is an isometric view showing a connection end and a locking mechanism of the multifunctional guitar according to one embodiment.

FIG. 7 is an isometric view of the locking mechanism.

FIG. 8 is an isometric exploded view of the locking mechanism.

FIG. 9 is an isometric cutaway view of the locking mechanism.

FIG. 10 is another isometric cutaway view of the locking mechanism.

FIG. 11 is still another partly exploded view of the multifunctional guitar.

FIG. 12 yet another partly exploded view of the multifunctional guitar.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

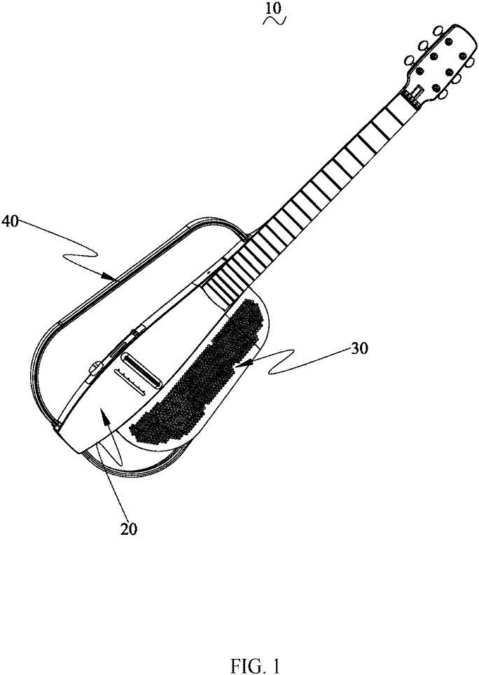

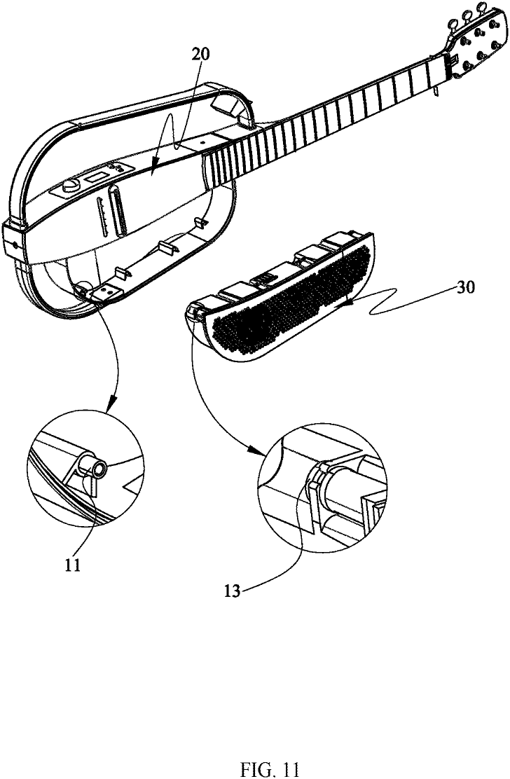

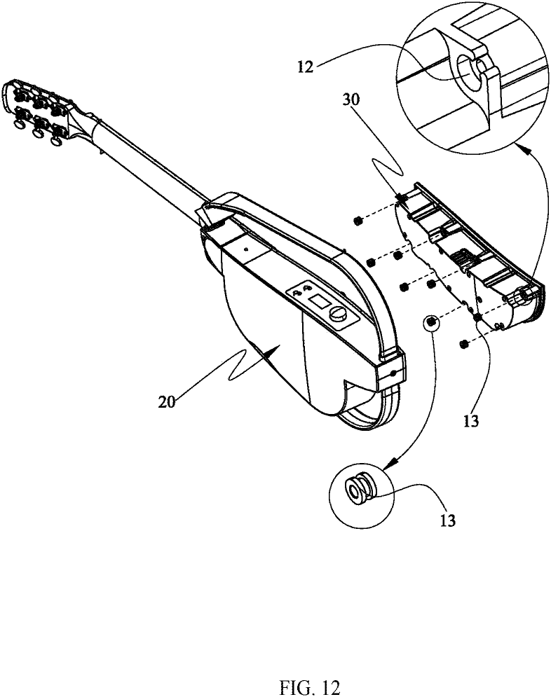

Referring to FIG. 1, a multifunctional guitar 10 may include a guitar body 20, a Bluetooth speaker 30, and a handle 40. The Bluetooth speaker 30 is connected to the guitar body 20 through a shock absorbing mechanism (see FIGS. 11 and 12). The handle 40 is detachably connected to the guitar body 20.

Referring to FIGS. 11 and 12, in one embodiment, the shock absorbing mechanism may include a post 11 arranged in the guitar body 20, a receiving hole 12 defined in the Bluetooth speaker 30, and a shock absorbing member 30. The post 11 is received in the receiving hole 12. The shock absorbing member 30 is hollow and cylindrical. The shock absorbing member 30 is arranged around the post 11 and received in the receiving hole 12.

If no shock absorbing mechanism is provided, the sound emitted by the sound cavity of the Bluetooth speaker 30 will generate vibration, which will then cause the entire guitar body and the strings to vibrate. When the strings vibrate, the pickup system will collect the sound repeatedly, which will cause the speaker to “ howl.”

By integrating the Bluetooth speaker 30 on the guitar body 20, the pickup on the electric guitar converts the vibration signal into an electrical signal, and the electrical signal is transmitted to the Bluetooth speaker 30 through built-in cables, and then is amplified by the Bluetooth speaker 30. With such configuration, a player does not need to carry a cumbersome external speaker. Since the Bluetooth speaker 30 is integrated on the guitar body 20 without changing the size of the original guitar frame, the functions of the guitar are more diversified. In addition, the Bluetooth speaker 30 can also be connected with an external communication device (such as a mobile phone) via Bluetooth, and the external communication device can transmit the sound to the Bluetooth speaker 30 through electrical signals, and the Bluetooth speaker 30 amplifies the sound, which further increase the function of the guitar.

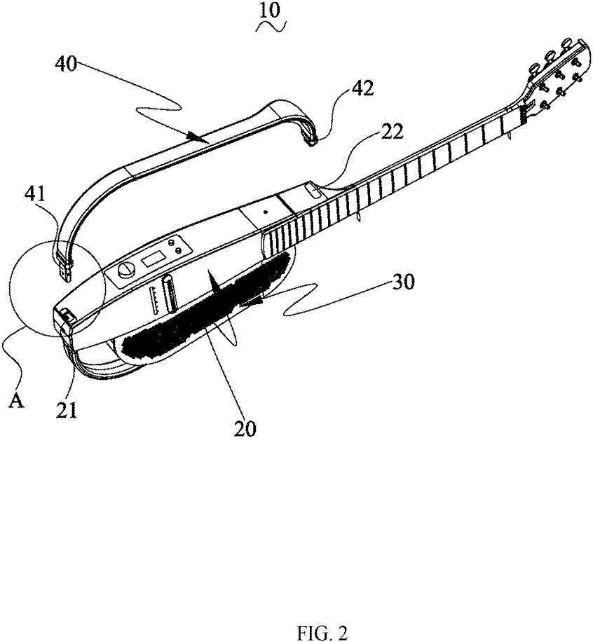

Referring to FIG. 2, in one embodiment, the guitar body 20 define a first receiving hole 21 and a second receiving hole 22. The handle 40 is a curved bar and has a first connection end 41 and an opposite second connection end 42 that are detachably inserted into the first receiving hole 21 and the second receiving hole 22, respectively

By proving the handle 40, the following functions are achieved:

In one aspect, the handle 40 functions as a handle, and a player can carry the entire guitar by holding the handle 40, which is very convenient.

In another aspect, since the handle 40 is a curved bar, the outer frame formed by the handle 40 can effectively cooperate with the guitar body 20. When a player is playing the guitar, the handle 40 will press against the corresponding part of the player’s body, so that the player can comfortably hold the guitar.

In still another aspect, with such configuration that the first connection end 41 and the second connection end 42 are detachably inserted into the first receiving hole 21 and the second receiving hole 22, the handle 40 can be attached to or removed from the guitar body according to actual needs. When the guitar is in use, the handle 40 can be attached to the guitar body 20. When the guitar is not in use, the handle 40 can be removed from the guitar body 20, which is convenient for storage and carrying.

Regarding how the handle 40 is detachably mounted on the guitar body 20, two embodiments are provided below.

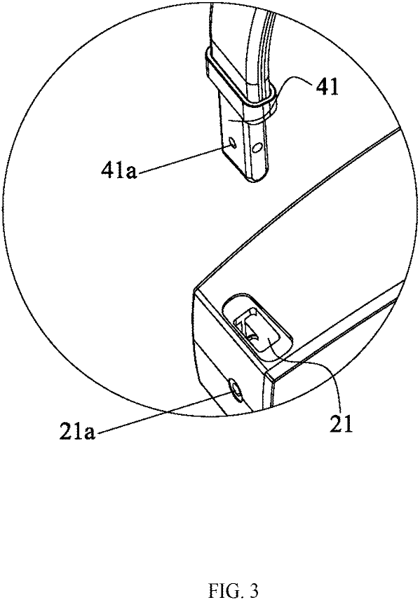

In one embodiment, the guitar 10 may include a first fastener (not shown) and a second fastener (not shown). Referring to FIG. 3, the first connection end 41 may define a first fastener hole 41a, and the guitar body 20 may define a first through hole 21a in communication with the first receiving hole 21. The first fastener passes through the first through hole 21a and securely fit in the first fastener hole 41a. The second connection end 42 defines a second fastener hole (not shown), and the guitar body 20 defines a second through hole (now shown) in communication with the second receiving hole 22. The second fastener passes through the second through hole and securely fit in the second fastener hole.

The first fastener and the second fastener may be bolts, and the first fastener hole and the second fastener hole may be threaded holes.

When the handle 40 needs to be mounted on the guitar body 20, the first connection end 41 can be first inserted into the first receiving hole 21, and the second connection end 42 can then be inserted into the second receiving hole 22. Then, the first fastener is passed through the first through hole 21 a and fastened to the first fastener hole 41a in the first connection end 41. The second fastener is passed through the second through hole and fastened to the second fastener hole in the second connection end 42. In this way, the handle 40 is mounted on the guitar body 20.

When the handle 40 needs to be detached from the guitar body 20, the first fastener can be reversely rotated so as to allow the first connection end 41 to be pulled out from the first receiving hole 21, and the second fastener can be reversely rotated so as to allow the second connection end 42 to be pulled out from the second receiving hole 22.

The handle 40 may be made of plastic material, which enables the guitar to be lightweight.

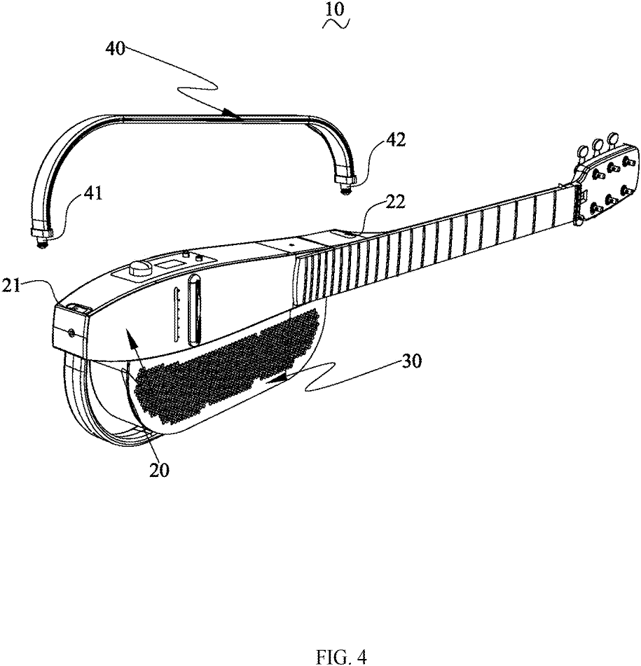

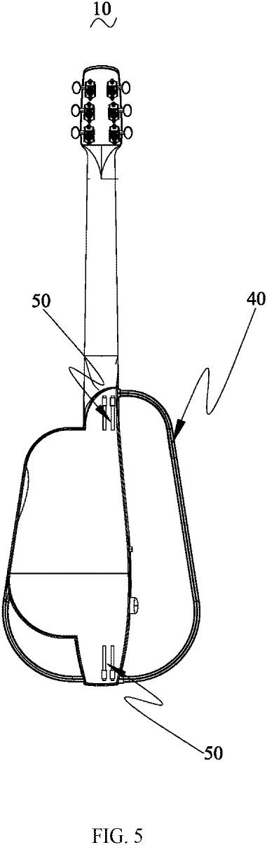

Referring to FIGS. 4-6, in another embodiment, a locking mechanism 50 is arranged in each of the first receiving hole 21 and the second receiving hole 22. The first connection end 41 and the second connection end 42 that are detachably locked in the first receiving hole 21 and the second receiving hole 22 through the locking mechanisms 50.

By proving the locking mechanism 50 in the first receiving hole 21 and the second receiving hole 22, the locking mechanisms 50 are integrated with the whole guitar, and the handle 40 can be attached to or removed from the guitar body conveniently without additional fasteners.

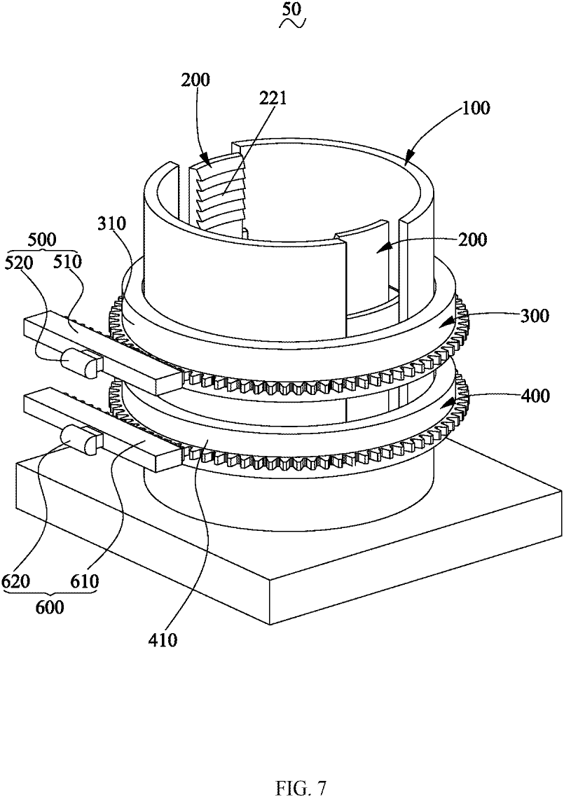

Referring to FIG. 7, in one embodiment, the locking mechanism 50 may include a barrel 100, a locking tab 200, a first rotating member 300, and a second rotating member 400.

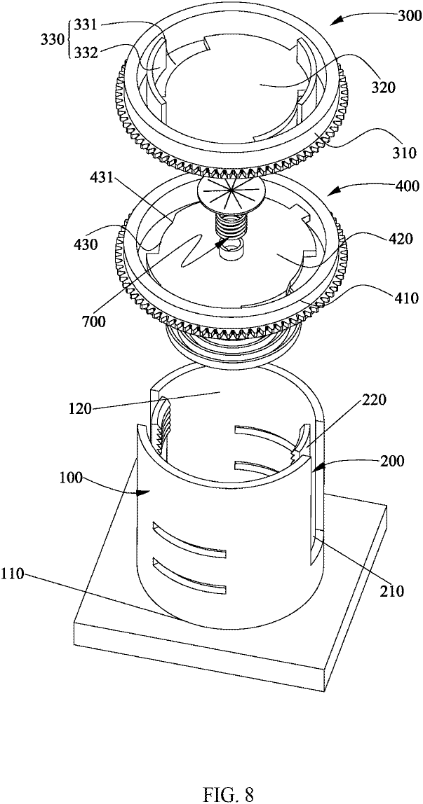

The barrels 100 of the locking mechanisms 50 are arranged in the first receiving hole 21 and the second receiving hole 22, respectively. Referring to FIG. 8, the barrel 100 has an open end 120 and a closed end 110.

The locking tab 200 protrudes from the closed end 110 of the barrel 100 and has a connection end 210 and an engagement end 220 adjacent to the open end 120 of the barrel 100. The connection end 210 is pivotally connected to the closed end 110 of the barrel 100 through a torsion spring (not shown).

As shown in FIG. 7, the first rotating member 300 and the second rotating member 400 are rotatably connected to the barrel 100. The first rotating member 300 is disposed close to the open end 120 of the barrel 100, and the second rotating member 400 is disposed close to the closed end 110 of the barrel 100.

Referring to FIG. 8, in one embodiment, the first rotating member 300 includes a first ring 310 arrange around the barrel 100, a first plate 320 connected to an inner lateral surface of the first ring 310 and arranged within the barrel 100, and a blocking structure 330 arranged within the first ring 310 and configured to prevent the locking tab 200 from deflecting.

Referring to FIG. 8, in one embodiment, the second rotating member 400 includes a second ring 410 arrange around the barrel 100, a second plate 420 connected to an inner lateral surface of the second ring 410 and arranged within the barrel 100, and a pushing structure 430 arranged within the second ring 410 and configured to deflect the locking tab 200.

Referring to FIG. 7, the locking mechanism 50 may further include a first sliding member 500 and a second sliding member 600 that are slidably connected to the guitar body 20. The first sliding member 500 includes a first rack 510 engaged with the first ring 310, and a first sliding button 520 fixed to the first rack 510 and partly external of the guitar body 20. The second sliding member 600 includes a second rack 610 engaged with the second ring 410, and a second sliding button 620 fixed to the second rack 610 and partly external of the guitar body 20.

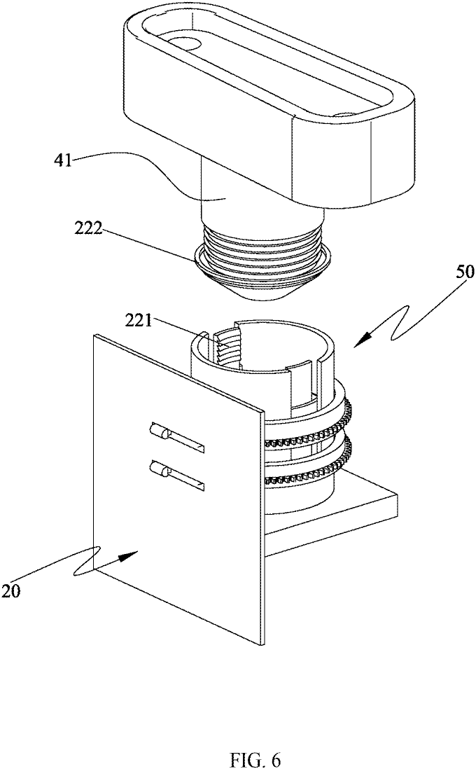

Referring to FIG. 6, in one embodiment, the locking tab 200 may include a number of one-way locking teeth 221 at the engagement end 220. The first connection end 41 and the second connection end 42 both include a protruding portion 222. The protruding portions 222 are to engage with one of the one-way locking teeth 221 to lock the first connection end 41 in the first receiving hole 21, and lock the second connection end 42 in the second receiving hole 22. The working principle of the above-mentioned locking mechanism 50 will be described below.

When the handle 40 needs to be mounted on the guitar body 20, the first connection end 41 can be first inserted into the first receiving hole 21. Since the locking tab 200 can be elastically deformed, the protrusion 222 will push the engagement end 220 of the locking tab 200 and cause the locking tab 200 to elastically deflect when the protrusion 222 of the first connection end 41 moves into the barrel 100. After the protrusion 222 completely passes over the engagement end 220, the locking tab 200 will return to its original shape, causing the engagement end 220 to return to its original position. After that, since the engagement end 220 is provided with the one-way locking teeth 221, the one-way locking teeth 221 restricts the protrusion 222 and prevents it from moving out of the barrel 100.

After the first connection end 41 is held in position in the first receiving hole 21, the second connection end 42 can be held in position in the second receiving hole 22 in the same manner by the locking mechanism 50. In this way, the handle 40 can be quickly and stably mounted on the guitar body 20.

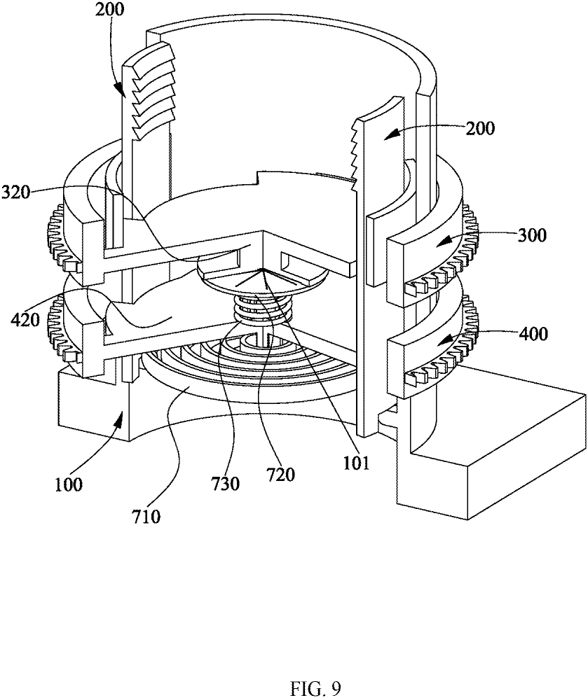

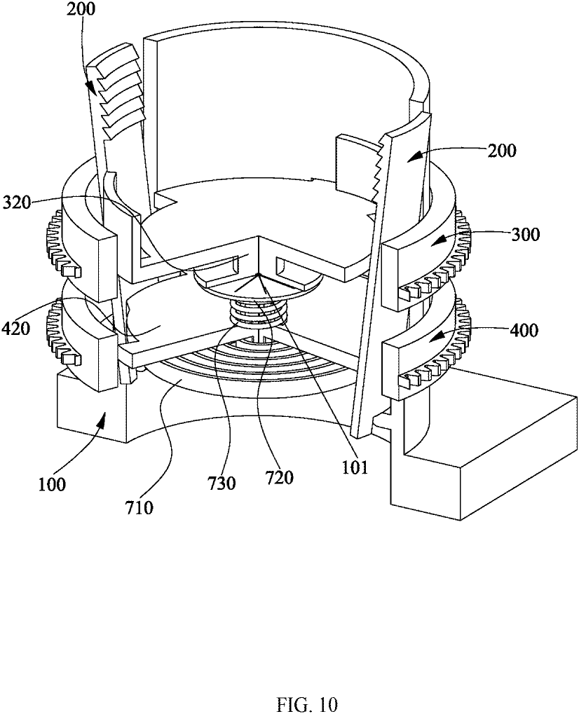

When the handle 40 needs to be removed from the guitar body 20, the first sliding button 520 can be first pushed to move by a user, which causes the first rack 510 to move. The first rack 510 then drives the first ring 310 to rotate. The first plate 320 rotates together with the first ring 310, causing the blocking structure 330 to rotate from a position (see FIG. 9) where the blocking structure 330 prevents the locking tab 200 from deflecting to a position (see FIG. 10) where the deflection of the locking tab 200 is not prevented by the blocking structure 330.

After that, the second sliding button 620 can then be pushed to move by a user, which causes the second rack 610 to move. The second rack 610 then drives the second ring 410 to rotate. The second plate 420 rotates together with the second ring 410, causing the pushing structure 430 to rotate. During rotation of the pushing structure 430, it pushes the locking tab 200 to deflect. After the locking tab 200 has deflected for a predetermined angle, one of the one-way locking teeth (i.e., the lowermost locking tooth in FIGS. 9 and 10) will come out of contact with the protrusion 222. The protrusions 222 can thus move out of the first receiving hole 21 and the second receiving hole 22. As a result, the first connection end 41 and the second connection end 42 can move out of the first receiving hole 21 and the second receiving hole 22.

As can be seen from the above, when the handle 40 needs to be detached from the guitar body 20, it needs to move the first sliding button 520 and the second sliding button 620 in turn. Such a structural design can fully ensure the stability of the handle 40 and the guitar body 20 during the connection process. If the sequence is not correct, the removal of the handle 40 cannot be achieved. Specifically, if a user attempts to move the second sliding button 620 first, the locking tab 200 cannot deflect because it is blocked by the blocking structure 330, which results in that the second sliding button 620 cannot move.

Referring to FIG. 8, in one embodiment, the blocking structure may include a first groove 331 defined in the first plate 320, and a protruding wall 332 protruding from the first plate 320. The locking tab 200 passes through the first groove 331. The protruding wall 332 is movable between a first position (see FIG. 9) where the protruding wall 332 is located between the locking tab 200 and an inner lateral surface of the barrel 100, and a second position (see FIG. 10) where the locking tab 200 directly faces the inner lateral surface of the barrel 100. In one embodiment, the second plate 420 has a curved edge 431, and a second groove 432 is formed between the curved edge 431 and the inner lateral surface of the barrel 100. The locking tab 200 passes through the second groove 432. The pushing structure 430 is the curved edge 431 and is movable between an original position (see FIG. 9) where the pushing structure 430 is spaced apart from the locking tab 200, and an unlocking position (see FIG. 10) where the pushing structure 430 comes into contact with and deflects the locking tab 200.

After the first connection end 41 and the second connection end 42 moves out of the first receiving hole 21 and the second receiving hole 22, a user needs to move the first sliding button 610 and the second sliding button 620 back to their original positions such that they are ready for the handle 40 to be attached to the guitar body 20 again.

It can be seen from the above that the first sliding button 610 and the second sliding button 620 are moved back to their original positions after the first connection end 41 and the second connection end 42 are moved out from the first receiving hole 21 and the second receiving hole 22. It would be convenient for a user if the relevant components can return to their original positions automatically without the annually resetting of the first sliding button 610 and the second sliding button 620.

To achieve the above-mentioned purpose, the locking mechanism 50 may further include a position resetting mechanism 700 (see FIG. 8).

Referring also to FIGS. 9 and 10, the position resetting mechanism 700 may include a return spring 710, a friction plate 720, and a pressing spring 730. In one embodiment, the return spring 710 is a spiral spring, and the pressing spring 730 is a cylindrical compression spring.

The return spring 710 is arranged between the second rotating member 400 and the barrel 100. The return spring 710 is to provide a torque to the second rotating member 400 to rotate the second rotating member 400 to its original position.

The friction plate 720 stays in contact with the first plate 320 of the first rotating member 300. In one embodiment, the friction plate 720 is connected to the second rotating member 40 via a key.

The pressing spring 730 is arranged between the friction plate 720 and the second rotating member 400. The pressing spring 730 is to provide a pushing force to the friction plate 720 to create a desired friction between the friction plate 720 and the first plate 320 of the first rotating member 300. In order to increase the frictional force between the friction plate 720 and the first plate 320, the friction plate 720 is in a surface-to-surface contact with the first plate 320. Friction protrusions 101 may be formed on the surface of the friction plate 720 which is in contact with the first plate 320.

The working principle of the above-mentioned position resetting mechanism 700 will be described below in conjunction with the process of detaching the handle 40 from the guitar body 20.

The first sliding button 520 can be first moved by a user. The first rack 510 then moves together with the first sliding button 520 and rotates the first ring 310. The first plate 320 then rotates together with the first ring 310. In this process, although there is friction between the friction plate 720 and the first plate 320, the frictional force is not enough to make the first plate 320 drive the friction plate 720 and the second rotating member 400 to rotate. This is because the return spring 710 provides a strong anti-torsion force for the second rotating member 400, and the friction force is not enough to overcome the anti-torsion force, thereby keeping the second rotating member 400 stationary. As a result, slippage occurs between the friction plate 720 and the first plate 320.

After the first plate 320 rotates to a position as shown in FIG. 10, the blocking structure 330 rotates to a position where the locking tab 200 frees from the restriction of the blocking structure 330 and can be deflected freely.

After that, the second sliding button 620 can be first moved by a user. The second rack 610 then moves together with the second sliding button 620 and rotates the second ring 410. The second plate 420 then rotates together with the second ring 410.

Here, it should be noted that the second sliding button 620 needs to be moved by a strong external force that is sufficient to overcome the anti-torsion force provided by the return spring 710, and makes the second rotating member 400 rotate. When the second rotating member 400 rotates, the pushing structure 430 rotates together with the second plate 420 and pushes the locking tab 200, thereby deflecting the locking tab 200. During this process, although there is friction between the friction plate 720 and the first plate 320, the first plate 320 has reached the limit position of its rotation and cannot be rotated further.

After the locking tab 200 has deflected for a predetermined angle, one of the one-way locking teeth (i.e., the lowermost locking tooth in FIGS. 9 and 10) will come out of contact with the protrusion 222. The protrusions 222 can thus move out of the first receiving hole 21 and the second receiving hole 22. As a result, the first connection end 41 and the second connection end 42 can move out of the first receiving hole 21 and the second receiving hole 22.

After the first connection end 41 and the second connection end 42 move out of the first receiving hole 21 and the second receiving hole 22, a user can stop exerting force on the second sliding button 620. The second rotating member 40 can then rotate back to its original position (see FIG. 9) due to the torque provided by the return spring. During this process, the friction plate 720 rotates together with the second rotating member 40. Due to the friction between the friction plate 720 and the first plate 320, the first plate 320 rotates together with the friction plate 720 and can rotate back to its original position (see FIG. 9). As a result, the blocking structure 330 on the first plate 320 moves back to its original position and can prevent the locking tab 200 from deflecting. The first rotating member 300 rotates back to its original position.

Here, it should be noted that, when the first rotating member 300 and the second rotating member 400 are both in the reset state (see FIG. 9), if a user attempts to move the second sliding button 620 first, the second sliding button 620 cannot drive the second plate 420 to rotate. Specifically, when the first rotating member 300 and the second rotating member 400 are both in the reset state, the locking tab 200 is restricted by the block structure 330 and cannot deflect, which prevents the pushing structure 420 of the second plate 420 from rotating. As a result, the second ring 410 is stopped from rotating, and the second sliding button 620 cannot move when a user attempts to move the second sliding button 620.

The embodiments above are only illustrative for the technical solutions of the present disclosure, rather than limiting the present disclosure. Although the present disclosure is described in detail with reference to the above embodiments, those of ordinary skill in the art should understand that they still can modify the technical solutions described in the foregoing various embodiments, or make equivalent substitutions on partial technical features; however, these modifications or substitutions do not make the nature of the corresponding technical solution depart from the spirit and scope of technical solutions of various embodiments of the present disclosure, and all should be included within the protection scope of the present disclosure.

What is claimed is:

1. A multifunctional guitar comprising:
a guitar body;
a handle detachably connected to the guitar body;
a Bluetooth speaker; and
a shock absorbing mechanism that connects the Bluetooth speaker to the guitar body.

2. The multifunctional guitar of claim 1, wherein the guitar body define a first receiving hole and a second receiving hole, the handle is a curved bar and comprises a first connection end and an opposite second connection end that are detachably received in the first receiving hole and the second receiving hole, respectively.

3. The multifunctional guitar of claim 2, further comprising a first fastener and a second fastener, wherein the first connection end defines a first fastener hole, the guitar body defines a first through hole in communication with the first receiving hole, the first fastener passes through the first through hole and securely fit in the first fastener hole; the second connection end defines a second fastener hole, the guitar body defines a second through hole in communication with the second receiving hole, the second fastener passes through the second through hole and securely fit in the second fastener hole.

4. The multifunctional guitar of claim 3, wherein the first fastener and the second fastener are bolts, and the first fastener hole and the second fastener hole are threaded holes.

5. The multifunctional guitar of claim 2, wherein the handle is made of plastic material.

6. The multifunctional guitar of claim 2, further comprising a locking mechanism arranged in each of the first receiving hole and the second receiving hole, wherein the locking mechanisms are configured to lock the first connection end in the first receiving hole, and lock the second connection end in the second receiving hole, respectively.

7. The multifunctional guitar of claim 6, wherein each of the locking mechanisms comprises:
a barrel having an open end and a closed end, wherein the barrels of the locking mechanisms are arranged in the first receiving hole and the second receiving hole, respectively;
a locking tab protruding from the closed end of the barrel and having an engagement end adjacent to the open end of the barrel, the locking tab comprising a plurality of one-way locking teeth, wherein the first connection end and the second connection end both comprise a protruding portion, the protruding portions are configured to engage with one of the one-way locking teeth of the locking tabs to lock the first connection end in the first receiving hole, and lock the second connection end in the second receiving hole;
a first rotating member rotatably connected to the barrel, the first rotating member comprising a first ring arrange around the barrel, a first plate connected to an inner lateral surface of the first ring and arranged within the barrel, and a blocking structure arranged within the first ring and configured to prevent the locking tab from deflecting;
a second rotating member rotatably connected to the barrel, the second rotating member comprising a second ring arrange around the barrel, a second plate connected to an inner lateral surface of the second ring and arranged within the barrel, and a pushing structure arranged within the second ring and configured to deflect the locking tab;
a first sliding member slidably connected to the guitar body, the first sliding member comprising a first rack engaged with the first ring, and a first sliding button fixed to the first rack and partly external of the guitar body; and
a second sliding member slidably connected to the guitar body, the second sliding member comprising a second rack engaged with the second ring, and a second sliding button fixed to the second rack and partly external of the guitar body.

8. The multifunctional guitar of claim 7, wherein the blocking structure comprises a first groove defined in the first plate, and a protruding wall protruding from the first plate, the locking tab passes through the first groove, the protruding wall is movable between a first position where the protruding wall is located between the locking tab and an inner lateral surface of the barrel, and a second position where the locking tab directly faces the inner lateral surface of the barrel; the second plate comprises a curved edge, a second groove is formed between the curved edge and the inner lateral surface of the barrel, the locking tab passes through the second groove, the pushing structure is the curved edge and is movable between an original position where the pushing structure is spaced apart from the locking tab, and an unlocking position where the pushing structure comes into contact with and deflects the locking tab.

9. The multifunctional guitar of claim 7, further comprising:
a return spring arranged between the second rotating member and the barrel, and configured to provide a torque to the second rotating member to rotate the second rotating member to an original position thereof;
a friction plate staying in contact with the first plate of the first rotating member; and
a pressing spring arranged between the friction plate and the second rotating member, the pressing spring is configured to provide a pushing force to the friction plate to create a desired friction between the friction plate and the first plate of the first rotating member.

10. The multifunctional guitar of claim 9, wherein the return spring is a spiral spring, the pressing spring is a cylindrical compression spring, the friction plate is in a surface-to-surface contact with the first plate of the first rotating member.
